(19) United States
(12) Patent Application Publication
(10) Pub. No.: US 2023/0128345 A1
(43) Pub. Date: Apr. 27, 2023

(54) COMPUTER-IMPLEMENTED METHOD AND SYSTEM FOR THE AUTOMATED LEARNING MANAGEMENT

(71) Applicants: API SRL, Milano (IT); KNOBS S.R.L., Milano (IT)

(72) Inventors: Massimo SPICA, Milano (IT); Vincenzo RANA, Milano (IT); Biancamaria MORI, Milano (IT); Mattia BIANCHI, Milano (IT); Luca PILLONI, Milano (IT)

(21) Appl. No.: 17/995,856

(22) PCT Filed: Apr. 9, 2021
(86) PCT No.: PCT/IB2021/052956

§ 371 Date: Oct. 8, 2022

(30) Foreign Application Priority Data
Apr. 10, 2020 (IT) 102020000007756

(51) Int. Cl. G09B 19/00

(52) U.S. Cl. CPC G09B 19/00; G09B 7/00

(57) ABSTRACT

A computer-implemented method for the automated learning management comprises the following phases: a phase of automatic registration of a user for the creation of a profile of the user; a phase of automatic monitoring of the presence and of the degree of attention of the user during the progress of a training course, for the acquisition of participation and attention data of the user during the course; and a phase of automatic verification of the skills of the user, for the generation of a certificate of attendance of the course.

### TECHNICAL FIELD

The present invention relates to a computer-implemented method and to a system for the automated learning management, usable for online learning (e-learning) and/or for the automation of in-person learning.

### BACKGROUND ART

Online learning (e-learning) platforms are well known and generally rely on the use of multimedia technologies and Internet connectivity to improve the quality of learning for users, by facilitating access to resources and services, remote material exchanges and remote collaboration.

However, the platforms of known type do require, for much of their core functionality, significant human input adapted to validate and verify the most sensitive and delicate parts of the usage process.

For example, as is well known, user identification plays a key role within platforms that issue certificates and certifications, as the identity of the person must be verified beforehand.

However, the user enrollment and verification phase must be performed in-person, a process that is often time-consuming and resource intensive.

In addition, current e-learning platforms are not able to adequately follow the user along his training path, in fact depriving themselves of information such as the degree of attention and involvement of the users themselves during the lessons followed.

### DESCRIPTION OF THE INVENTION

The main aim of the present invention is to devise a computer-implemented method and a system for the automated learning management that will minimize human intervention while also ensuring, autonomously and automatically, the basic steps that accompany the user during use.

Another object of the present invention is to devise a computer-implemented method and a system for the automated learning management that allow active monitoring of user’s behavior during lessons, so as to extrapolate useful information both for teaching evaluation and preparatory to the user’s final assessment.

Another object of the present invention is to devise a computer-implemented method and a system for the automated learning management that allow for completely transparent management of the user’s sensitive data in the hands of individual users.

Another object of the present invention is to devise a computer-implemented method and a system for the automated learning management that allow the issue of certificates proving the passing of a given course in digital format and the certification of the same, thus allowing the integration and subsequent use by third parties of the aforementioned certificates, subject to authorization by the user.

The objects set out above are achieved by the present computer-implemented method for the automated learning management according to the characteristics of claim 1.

The objects set out above are achieved by the present system for the automated learning management according to the characteristics of claim 18.

### BRIEF DESCRIPTION OF THE DRAWINGS

Other characteristics and advantages of the present invention will become more evident from the description of a preferred, but not exclusive, embodiment of a computer-implemented method and a system for the automated learning management, illustrated by way of an indicative, yet non-limiting example, in the accompanying tables of drawings wherein:

FIG. 1 is a general diagram illustrating phases of automatic registration, automatic monitoring and performing an automatic verification test of the method and system according to the invention;

FIG. 2 and FIG. 3 are general diagrams showing the management of the user’s sensitive data implemented in the method and system according to the invention.

### EMBODIMENTS OF THE INVENTION

The computer-implemented method and the system according to the invention aim to offer e-learning courses or in-presence courses to the enrolled users, to monitor their degree of attention during the learning sessions (e-learning or in-person) and to issue certificates of participation and detailed digital certificates on the overall progress of the user, including the final assessment.

In actual facts, the method and the system according to the invention automate the entire process of interacting with the users by carrying out the following activities:
verification of the identity of users during registration;
analysis of the actual attendance of users during courses and of the attention shown during lessons;
issue of official certificates and certifications to the users, based on the information collected.

In addition, the entire process fully complies with GDPR regulations to safeguard the users’ privacy and personal data.

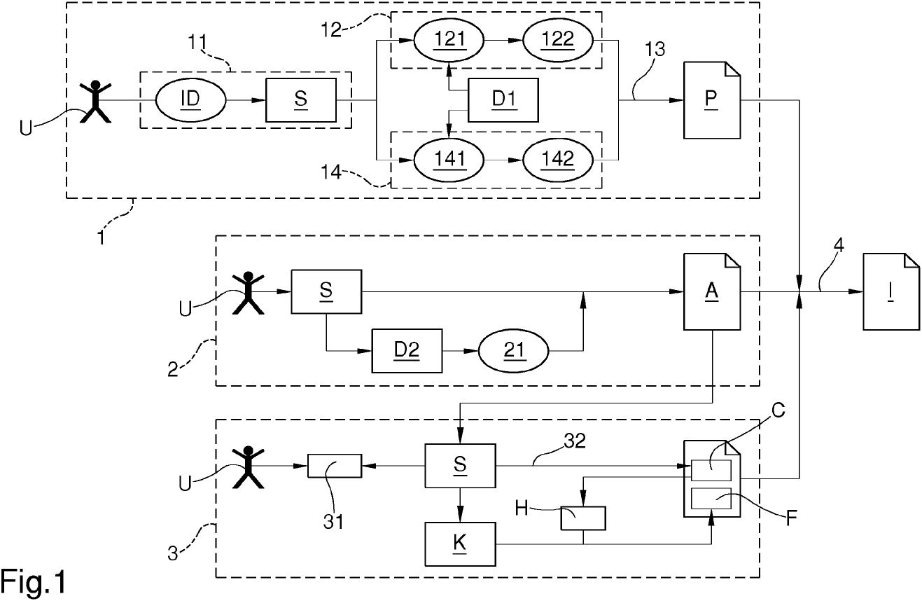

In particular, as schematically shown in FIG. 1, the computer-implemented method for the automated learning management comprises at least the following phases:
automatic registration of at least one user U for the creation of a profile P of the user U (phase 1);
automatic monitoring of the presence and of the degree of attention of the user U during the progress of a training course, for the acquisition of participation and attention data A of the user U during the course (phase 2);
automatic verification of the skills of the user U, for the generation of a certificate C of attendance of the course (phase 3).

The automated learning management system comprises a software and/or hardware platform for the execution of the steps of all the phases of the method according to the invention. Such a platform is schematized in FIG. 1 with the block indicated by reference S.

Specifically, the phase 1 of registration comprises at least the steps described below.

First, the phase 1 of registration comprises a step 11 of receiving registration information by the user U (social security number, first name, last name, date of birth) and of receiving an identity document ID of the user U comprising certified biometric information.

Therefore, a new user U must first provide, in addition to conventional registration information, an identity document ID bearing certified biometric information.

In addition, the phase 1 of automatic registration comprises a step 12 of automatic verification of the identity of the user U.

Specifically, such a step of verification 12 comprises a step 121 of acquiring biometric data of the user U by means of at least one electronic acquisition device D1 and a step 122 of comparing the acquired biometric data (face, fingerprint, voice print, etc.) with the certified biometric information contained in the identity document ID.

In the event of such verification being positive, i.e., in the event of the acquired biometric data corresponding to the certified biometric information, the phase 1 of automatic registration comprises a step 13 of creation of the profile P of the user U. In particular, such user profile P comprises at least the registration information and the acquired biometric data.

Specifically, the certified biometric information comprises at least one of the following: a photo of the user U (such as e.g. a photograph of the user’s valid ID card, driver’s license, or passport), a fingerprint of the user U, a voice print of the user U, a retinal scan of the user U, a handwritten signature or a fingerprint of the user U, behavioral information traceable to the user U, comprising, e.g., previous responses of the user U to specific and predefined questions.

According to a possible embodiment, the step 12 of automatic verification of the identity of the user U may comprise an analysis of the validity of the identity document ID. For example, such further analysis may comprise checking the expiration date of the identity document ID and/or of the associated name.

Preferably, the electronic acquisition device D1 for acquiring the biometric data of the user comprises at least one of the following: a fingerprint reader, a video camera (webcam) configured to acquire at least one image of the face of the user U, a microphone configured to acquire a voice print of the user U, a retinal scanner, a 3D recognition sensor, a handwriting reader with a stylus for signature/text input. Thus, possible solutions involve fingerprint recognition, retinal recognition, voice print recognition, face recognition, signature and/or handwriting recognition.

In addition, according to a possible embodiment, the phase 1 of registration comprises at least one step 14 of verification of the actual presence of the user U during the course.

In particular, according to a possible and preferred embodiment, such step 14 of verification of the presence of the user U comprises a step 141 of acquiring, by means of at least one video camera D1, a plurality of images of the face of the user U in different positions and/or of acquiring, by means of at least one microphone D1, at least one predefined sentence spoken by the user U.

For example, the movements of the face to certain positions can be required from the user U via specific on-screen instructions or audio requests.

Furthermore, the step 14 of verification of the presence of the user U comprises a step 142 of ascertaining the presence of the user U by means of a biometric recognition algorithm, starting from the acquired images and/or the acquired sentences.

In particular, the biometric recognition algorithm used to ascertain the user’s presence depends on the type of biometric data being analyzed. For example, a webcam can be used to capture information about the mood and movements of the user U, while interactive pop-ups can be shown on screen which must be clicked by the users themselves. These algorithms can be combined to increase the accuracy thereof.

Therefore, in the case of biometric face recognition, for example, it is possible to verify the actual presence in front of the device D1 of the user U to be registered, e.g. by using a simple webcam. The extrapolated images can be analyzed in real time and compared, for example, with the image on the requested identity document ID (ID card, driver’s license, passport). If the verification is successful, the identification of the user U for the purposes of registration on the platform S can be considered completed.

As schematically shown in FIG. 1, the phase 2 of monitoring comprises at least one step 21 of acquiring participation and attention data A of the user U by means of at least one electronic control device D2.

In particular, the electronic control device D2 of the participation and attention data A comprises at least one of the following: a fingerprint reader, a video camera (webcam) configured to acquire at least one image of the face of the user U, a microphone configured to acquire a voice print of the user U, a retinal scanner, a 3D face recognition sensor, a mouse and a keyboard (used, e.g., to interact with interactive pop-ups displayed on the screen).

Conveniently, according to a possible and preferred embodiment, the electronic control devices D2 used for monitoring correspond, at least partly, to the electronic acquisition devices D1 used during the previous registration.

Specifically, according to a possible embodiment, the step 21 of acquiring participation and attention data A of the user U comprises the use of an active interaction algorithm with the user U, configured to communicate directly with such a user to request and verify predetermined actions by means of the electronic control device D2.

According to a possible embodiment, the step 21 of acquiring participation and attention data A of the user U comprises, in addition to or as an alternative to the active interaction algorithm, a passive detection algorithm, configured to detect the movements and actions of such a user by means of the electronic control device D2 during the training course.

These algorithms may be of different types depending on the type of device used and available to the user U. In addition, such algorithms may be combined with each other to obtain more accurate results.

According to a possible embodiment, the electronic control device D2 comprises at least one video camera and the step 21 of acquiring participation and attention data A of the user U comprises:
acquiring a plurality of images relating to the position of the eyes and/or face of the user U during the training course;
starting from the acquired images, determining the eye and/or face movements of the user U during the training course;
comparing the movements determined with predefined parameters to calculate the degree of attention of the user U.

For example, during the comparison it is possible to check whether the gaze of the user U follows the slide input direction.

The participation and attention data A may comprise at least one of the following:

response of the user U to pop-ups on screen, movements of the gaze of the user U, indications relating to patterns proposed on screen and followed or not by the user U, indications relating to the response or not by the user U to interactions with at least one electronic control device D2, indications relating to the passive response of the user U to stimuli such as showing an image on screen.

Therefore, during normal course attendance, possibly divided into sessions, the user U is invited to participate in the training, in front of their computer or via other electronic control devices D2 both mobile and wearable, by reading, listening to the proposed contents, interacting in a virtual environment and/or in a training video game.

It cannot however be ruled out the monitoring of the users during the training courses to be held in-person, using appropriate electronic control devices D2. In such a case, for example, the electronic control devices D2 may comprise a plurality of video cameras suitably arranged and oriented inside the area in which the course is held.

Thus, thanks to the use of dedicated devices (webcam, microphone, retinal scanner, fingerprint recognizer or other devices) with which the electronic control device D2 used by the user U must be provided, essential information about their degree of attention to what is presented to them is retrieved.

Conveniently, the same tools allowing for the identification and verification of the user during the registration phase, may be used during the monitoring phase to assess the degree of interaction of the user U with the system, for example, by distinguishing a photo placed in front of the webcam from the actual presence of the user U, by analyzing the responses verbally provided by the user, up to the possibility of following the gaze of the user U, thus defining the points of interest on the screen on which the course is presented and then recording any drops in attention.

In addition, the participation and attention data A of several users U acquired in this way can be analyzed, in an anonymous fashion, to determine the overall degree of attention of the users, thus of an entire class, towards a given course. Therefore, the analysis carried out using the method according to the invention strongly helps the platform S in the evaluation phase of the individual user, but it also provides interesting data to support the course evaluation, by providing useful feedback on the overall degree of attention of the users. These suggestions may help the course creators understand the weaknesses of the lessons, allowing them to improve them.

As schematically shown in FIG. 1, the phase 3 of automatic verification of the skills of the user U comprises at least the following steps:
a step 31 of performing an automatic verification test runs of the user U;
if the verification test is passed and/or if, starting from the participation and attention data A detected, the degree of attention turns out to be higher than a predefined minimum degree of attention, a step 32 of automatic generation of the certificate C of attendance of the course.

Specifically, the generated certificate C comprises at least one of the following information: references of the course passed, final assessment, percentage of modules followed or successfully passed and execution time of the examination. Moreover, the certificate C, in addition to proving the passing of the course, contains information such as the quality and degree of preparation of the users U, their degree of attention and the interest shown during the course.

Advantageously, as shown in FIG. 1, the method comprises the signature F of the certificate by means of a private key of the user U. Preferably, the signature F is obtained using an asymmetric key algorithm. Specifically, the signature F is obtained starting from a private key K of the user U used to encrypt a hash H of the certificate C.

Therefore, at the end of the course, the user U is required to take an examination that evaluates his/her preparation on the subject matter.

The platform S, in assessing the exam, may use the previously collected participation and attention data A of the user U.

This examination, whether passed, qualifies the user U for the topics covered in the course. Therefore, if the assessment achieved turns out to be positive, the method according to the invention creates a certificate C containing the user’s information, digitally signs it to guarantee the authenticity thereof, preferably with an asymmetric key algorithm, and delivers it to the users themselves. Conveniently, the method provides for the revocation of the issued certificates C, under predefined conditions.

As schematically shown in FIG. 1, the method according to the invention comprises at least one step 4 of generating personal information I of the user U comprising at least one of the following: the profile P of the user U comprising the registration information and the acquired biometric data; the participation and attention data A of the users themselves; and the certificate C.

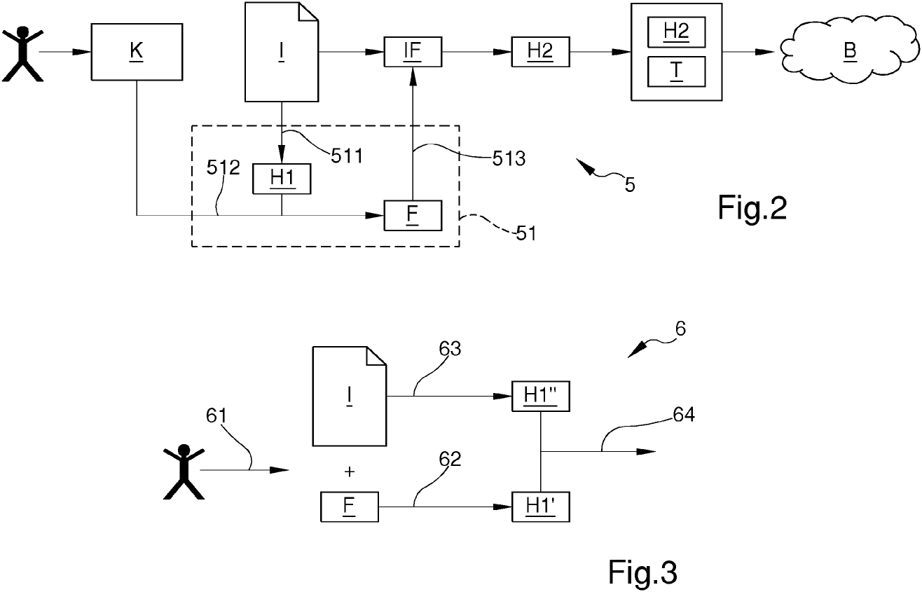

Advantageously, as shown in FIG. 2, the method also comprises at least one phase 5 of authentication and encryption of the collected personal information I. Specifically, this phase 5 of authentication and encryption comprises the following steps:
a step 51 of authenticating the personal information I by means of digital signature F of the user U, for the generation of authenticated personal information IF;
a step 52 of masking the authenticated personal information IF for the generation of masked information H2 not traceable to the authenticated personal information IF;
a step 53 of uniquely associating the masked information H2 with a time stamp T and of storing the marked information thus obtained.

In particular, according to a preferred embodiment, the step 51 of authentication comprises the performance of an asymmetric encryption of personal information I starting from a private key K of the user U, for the generation of a digital signature F verifiable by means of a public key of the users themselves.

Specifically, as shown in FIG. 2, the step of authenticating 51 comprises a step 511 of generating a hash H1 starting from the personal information I and a step 512 of performing an asymmetric encryption of the hash H1 generated starting from a private key K of the user U for the generation of the digital signature F.

Furthermore, the step of authenticating 51 comprises a step 513 of associating the digital signature F with the personal information I to obtain the authenticated personal information IF.

Preferably, the step of masking 52 comprises the performance of a cryptographic hash function on the authenticated personal information IF to obtain the masked information H2.

Advantageously, the step 53 of uniquely associating the masked information H2 with a time stamp T is implemented by means of a block chain B.

As shown in the diagram in FIG. 3, in the event of the user U being interested in using his or her certificate C, the method comprises at least one phase 6 of verification of the personal information I, comprising at least the following steps:
retrieve the masked information H2 stored on the blockchain;
a step 61 of decrypting the masked information H2 by means of a public key of the user U to obtain the personal information I and the signature F of the user U;
a step 62 of decrypting said signature F of the user U by means of a public key to obtain a first hash H1′;
a step 63 of generating a second hash H1″ starting from the personal information I;
a step 64 of verifying whether the first hash H1′ and the second hash H1″ are equal.

Therefore, the method and the system according to the invention process the data provided by the user U and produced during the entire user experience in a completely anonymous and transparent way.

This is ensured by the use of an asymmetric key encryption mechanism that ensures the ownership of the personal information produced, in combination with the use of a hashing algorithm, e.g. of the SHA-256 type, which allows masking the personal information I to anyone who is not the owner of the data, or authorized by the same.

Downstream of this processing, the system receives the masked information and provides, through the use of APIs (e.g. Web3 for JavaScript or Python), to upload it to the blockchain (e.g. Ethereum).

This operation ensures that the masked information is accessible to any third party entity or individual and provides a legally valid link to a time stamp.

In this way, the user U owner of the information may, at their discretion, grant permission for unencrypted viewing of, e.g., one of their certificates C.

At that point, the body to which the authorization has been granted can easily verify that the certificate C has been issued by the platform S, has actually been obtained by the user U involved and can place the issue in a specific time instant.

The platform S of the system according to the invention comprises:
a registration software module provided with a graphic interface for the performance of the phase 1 of automatic registration of the user U and of the creation of a profile P of the user themselves;
at least one electronic acquisition device D1 of the biometric data of the user U operationally connected to the registration software module.

In addition, the platform S comprises:
a monitoring software module for the performance of the phase 2 of automatic monitoring of the presence and of the degree of attention of the user U during the progress of a training course;
at least one electronic control device D2 operatively connected to the monitoring software module.

In addition, the platform S comprises an examination software module for the performance of the phase 3 of automatic verification of the skills of the user U and for the generation of the certificate C of attendance of said course.

Furthermore, the platform S comprises a remote computing unit comprising means for performing the phase 5 of authentication and encryption of the collected personal information I and of the phase 6 of verifying the personal information I.

Conveniently, the remote computing unit comprises at least one remote server configured to communicate with a blockchain technology B.

It has in practice been ascertained that the described invention achieves the intended objects.

In particular, the fact is emphasized that the computer-implemented method and the system according to the invention allow drastically reducing human intervention and guarantee, in an autonomous and automatic manner, the fundamental steps that accompany the user during use.

In particular, the method and the system according to the invention allow achieving multiple benefits, listed below.

In particular, the method and the system according to the invention allow for the active monitoring of the user’s behavior during the lessons, so as to extrapolate useful information for both the evaluation of the teaching, and preparatory to the final assessment of the user.

Moreover, the method and the system according to the invention allows for a completely transparent management of the sensitive user data in the hands of individual users. The platform does not know any personal data, as all collected data are encrypted and signed by the user, and then uploaded to the blockchain. This ensures that the platform managers cannot access or use any confidential data and, at the same time, returns full ownership of their personal information to the user, allowing them to exploit it as they see fit.

In addition, the method and the system according to the invention allow the issue of certificates proving the passing of a given course in digital format and the notarization of the same on the blockchain, thus allowing the integration and subsequent use by third party entities of the aforementioned certificates, subject to the user’s authorization.

1. A computer-implemented method for the automated learning management, said computer-implemented method comprising:
at least one phase of automatic registration of at least one user for the creation of a profile of said user;
at least one phase of automatic monitoring of the presence and of the degree of attention of said at least one user during the progress of a training course, for the acquisition of participation and attention data of said at least one user during said course; and
at least one phase of automatic verification of the skills of said at least one user, for the generation of a certificate of attendance of said course.

2. The computer-implemented method according to claim 1, wherein said phase of registration comprises at least the following steps:
a step of receiving registration information by said user;
a step of receiving at least one identity document of said user comprising certified biometric information; and
a step of automatic verification of the identity of said user, comprising at least one step of acquiring biometric data of said user by means of at least one electronic acquisition device, and a step of comparing said acquired biometric data with said certified biometric information contained in the identity document; wherein
in the event of said step of verification is positive, at least one step of creation of said profile of said user comprising at least said registration information and said acquired biometric data.

3. The computer-implemented method according to claim 2, wherein said certified biometric information comprises at least one of the following: a photo of said user, a fingerprint of said user, a voice print of said user, a retinal scan of said user, a handwritten signature or a fingerprint of said user, behavioral information traceable to said user.

4. The computer-implemented method according to claim 2, wherein said step of automatic verification of the identity of the user comprises at least one step of analyzing the validity of said identity document.

5. The computer-implemented method according to claim 2, wherein said electronic acquisition device for acquiring the biometric data of the user comprises at least one of the following: a fingerprint reader, a video camera configured to acquire at least one image of the face of said user, a microphone configured to acquire a voice print of said user, a retinal scanner, a 3D recognition sensor, a handwriting reader with a stylus for signature/text input.

6. The computer-implemented method according to claim 1, wherein said phase of registration comprises at least one step of verification of the presence of said user.

7. The computer-implemented method according to claim 6, wherein said step of verification of the presence of said user comprises at least the following steps:
at least one step of acquiring by means of at least one video camera a plurality of images of the face of said user in different positions and/or of acquiring by means of at least one microphone at least one predefined sentence spoken by said user; and
a step of ascertaining the presence of said user by means of a biometric recognition algorithm and starting from said acquired images and/or said acquired sentences.

8. The computer-implemented method according to claim 2, wherein said phase of monitoring comprises at least one step of acquiring participation and attention data of said user by means of at least one electronic control device.

9. The computer implemented method according to claim 8, wherein said electronic control device of the participation and attention data comprises at least one of the following: a fingerprint reader, a video camera configured to acquire at least one image of the face of said user, a microphone configured to acquire a voice print of said user, a retinal scanner, a 3D recognition sensor, a handwriting reader with a stylus for signature/text input.

10. The computer-implemented method according to claim 8, wherein said step of acquiring participation and attention data of said user comprises the use of an active interaction algorithm with said user, configured to communicate directly with said user to request and verify predetermined actions by means of said electronic control device, and/or of a passive detection algorithm, configured to detect movements and actions of said user by means of said electronic control device during said training course.

11. The computer-implemented method according to claim 8, wherein said electronic control device comprises at least one video camera and said step of acquiring participation and attention data of said user comprises:
acquiring by means of said video camera a plurality of images relating to the position of the eyes and/or face of said at least one user during said training course;
starting from said acquired images, determining the eye and/or face movements of said at least one user during said training course; and
comparing said movements determined with predefined parameters to calculate the degree of attention of said at least one user.

12. The computer-implemented method according to claim 8, wherein said participation and attention data comprise at least one of the following: at least one response of said user to pop-ups on screen, movements of said user’s gaze, indications relating to patterns proposed on screen and followed or not by said user, indications relating to the response or not by said user to interactions with at least one electronic control device, indications relating to the passive response of said user to stimuli such as showing an image on screen.

13. The computer-implemented method according to claim 1, wherein said phase of automatic verification of the skills of the user comprises at least the following steps:
at least one step of performing an automatic verification test of said at least one user; wherein
if said verification test is passed and/or if said degree of attention is higher than a predefined minimum degree of attention, at least one step of automatic generation of said certificate of attendance of said course.

14. The computer-implemented method according to claim 1, wherein said generated certificate comprises at least one of the following information: references of the course passed, final assessment, percentage of modules followed or successfully passed, execution time of the examination.

15. The computer-implemented method according to claim 1, wherein the computer-implemented method comprises the signature of said certificate by means of a private key of said user.

16. The computer-implemented method according to claim 1, further comprising: at least one step of generating personal information of said user comprising at least one of: said profile of the user comprising said registration information and said acquired biometric data; said participation and attention data of the user; said certificate.

17. The computer-implemented method according to claim 16, further comprising at least the following steps:
at least one step of authenticating said personal information by means of digital signature of said user, for the generation of authenticated personal information;
at least one step of masking said authenticated personal information for the generation of masked information not traceable to said authenticated personal information; and
at least one step of uniquely associating said masked information with a time stamp and storing the marked information
obtained.

18. A system for the automated learning management comprising a platform for the execution of the method steps according to claim 1.

19. A computer-implemented method for the automated learning management, said computer-implemented method comprising:
registering, automatically, at least one user for the creation of a profile of said user;
monitoring, automatically, the presence and of the degree of attention of said at least one user during the progress of a training course, for the acquisition of participation and attention data of said at least one user during said course; and
verifying, automatically, the skills of said at least one user, for the generation of a certificate of attendance of said course.

20. A system for the automated learning management comprising:
a tangible device configured and/or programmed to automatically register at least one user for the creation of a profile of said user, wherein
said tangible device is further configured and/or programmed to automatically monitor the presence and of the degree of attention of said at least one user during the progress of a training course, for the acquisition of participation and attention data of said at least one user during said course; and
said tangible device is further configured and/or programmed to verify the skills of said at least one user, for the generation of a certificate of attendance of said course.
